(19) United States
(12) Patent Application Publication
(10) Pub. No.: US 2002/0063549 A1
(43) Pub. Date: May 30, 2002

(54) Perpetual motion energy of (GOD) on countenance entry and motor starting in a vehicle

(76) Inventor: Herbert R. Floyd, New York, NY (US)

Correspondence Address: HERBERT R. FLOYD, P.O. BOX 286779, NEW YORK, NY, 10128, US

(21) Appl. No.: 09/726,280

(22) Filed: Nov. 30, 2000

(51) Int. Cl. H02J 7/00

(52) U.S. Cl. 320/103

(57) ABSTRACT

Perpetual motion energy defining two 12 V DC batteries, two DC-AC converters, and two DC-AC adaptors for connecting, therewith the converters, and the batteries, each battery is located in a conventional battery charger, such that both of the batteries define fully charged operating current thereby to charge one another until two relays open duplex circuits. Two cartridges containing restorable properties for extended perpetual battery life are provided, and are drained therein each battery, whenever, operating voltage levels are low. A countenance entry system, outwardly on a door is provided to turn on a vehicle's motor, activate a heater, a hood opener, a trunk opener, a power window, and offers legal entry via a video recorder recording a user's face as each switch is on.

### BACKGROUND OF THE INVENTION

1. Field of the Invention

The present invention refers to energy and specifically to public utilities, electric vehicles, and transference all of which will be controlled by a SECRECY ORDER USA PERPETUAL MOTION ENERGY act. This act will be such that in process of time vehicles each of which including an internal combustion engine will become obsolete, i.e., preventing air pollution.

X Department of Energy (General Provisions) (Parts 1000 1099), and XXXI Office of Environmental Quality with respect to the Department of Agriculture (Parts 3100 3199) by way of CFR, thus will regulate and control PERPETUAL MOTION ENERGY. P.M.E. (PERPETUAL MOTION ENERGY) systems will save thousands of dollars yearly, in maintenance cost for US organizations. While safety, and environmental concerns each of which is an important issue, a P.M.E. Electrically Powered Locomotive is to provide high Perpetual motion energy concerning its load. On earth, only one nation will be generating Giant Perpetual Motion Energy Systems; namely, THE UNITED STATES OF AMERICA.

2. Description of the Prior Art

PERPETUAL MOTION ENERGY is a revolutionary 21st Century reality for which AMERICA will not have to depend on foreign oil, such as gasoline and/or petroleum. PERPETUAL ENERGY is a dominating power from (GOD), thus, presented to applicant, as a gift such that he will teach it under the provisions of the Code of Federal Regulations.

### SUMMARY OF THE INVENTION

Accordingly, one object of the present invention is to, thus, provide perpetual motion energy for vehicles, such, as Automobiles, Trucks, Tractors, “Motorboats,” Ships, Aircraft modes for Transportation, Buses, Motorcycles, Scooters, Fire Fighting Apparatus, Snow Removal Equipment, Hydraulic jacks, Forklifts; even, Substations, and Generating Stations.

Accordantly, it is a principle object about this modern invention to generate a perpetual motion energy system about (GOD), public utilities, electric vehicles regarding face or countenance entry and motor starting via two self-chargeable batteries. Therefore, to accomplish the foregoing and other objects, a perpetual motion energy system defining a vehicle according to the present invention comprises a charging mode having two batteries in a vehicle, a first battery is to fit a first charger, whereby a second battery is to fit a second charger, a first DC-AC converter system and a first plug, so as to fit a first hole via the first charger, a second DC-AC converter system has a second plug to fit the second charger and a way for the batteries to charge each other, a first AC adaptor, and a third plug to fit a first jack upon the first charger, as the adaptor part is to fit a first socket of the second converter, the second charger uses a way to output DC current to charge the first battery, a second AC adaptor and a fourth plug to fit a second jack on the second charger, as the adaptor is to befit a second socket concerning the first converter, the first charger now has a way to output current to charge the second battery, a relay system for freeing the batteries from power, and a drain mechanism for draining two battery cartridges. The charging mode includes a first, and second LED to indicate low charge as two relays are to close two circuits. The batteries have a way to lode perpetually, as a third LED says full, the relay system thereby stops all charging. The batteries connected in series and/or parallel so, each circuit operates the same, as one another, a fourth and fifth LED regarding both chargers emit light compatibly. The charging mode is connected to an electric motor, so that the batteries include ways to operate when the motor is off. The cartridges have tubs of electric nonmetallic conductors, a solvent to dissolve and a sixth LED concerning operations. The cartridges having two drain holes below, two plugs under two helixes, a gear motor of a system to spin the plugs, and two floor angles to drain the tubs. According to additional merit concerning the invention, a perpetual energy system of (GOD) comprises a charging system having dual batteries each of which is sized to fit a first and second charger, a DC-AC converter system is for converting DC current to AC current, thereby two DC to AC converters, an AC adaptor system is for connecting and charging the batteries by way of the DC to AC converters, a countenance entry system is for so entering in a vehicle via face data inputted, optically, through a first shield, and into a system, a first video recorder includes a system to record a face of a legal user, an image sensor has a system which changes countenance images from optical input to computer data or a signal, a control system is to control perpetual energy including ways for outputting a commandment signal, an unlock mode for freeing door-locks, and actuators actuating, thereby a first unit switch being operated, such, as to gain entry, a seventh LED is to illuminate the shield, a first input system defines the first shield, the recorder, a transmitter and a second unit switch joined to the control system to so output a unit signal via the transmitter, turns on a motor by the unit switch as the recorder tapes the face of a user, the transmitter having a system to track the unit signal by transmitting one face and/or countenance signal, a comparison system is for comparing the data and has a memory to store a preset countenance signal, so, as the countenance signal matches the preset countenance signal stored into the memory, the comparison system outputs the commandment signal thereby. The recorder, and the transmitter are in a door of the vehicle, since three antennas are to receive the signal. The vehicle is a conventional electrical vehicle having dual battery boxes to fit two battery chargers. The motor having a systems to propel the vehicle thereby, upon a surface, the charging system is to improve conventional alternator output thereafter. The door having a heater switch, window switch, a hood and trunk switch outwardly, and ways for all switches to operate, each switch is to operate while the face about a user is recorded at the same time that each switch is used.

According to further merit regarding the new invention, a perpetual energy system via (GOD) comprises a second input system defining a second shield in a dashboard to input data optically in a system to be computer data, so as to output a face, and/or countenance signal, a second motor switch has a system to turn on a motor by using the shield, a video image converter system, such as to convert the signal from a first and second video recorder, a third input system, and a third shield including a third motor switch upon a door, therein a a vehicle, and ways for a user to input data optically, into a system to arise, as computer information, outputs the face signal, as the third motor switch is used, an image negative system for generating a negative image about the face signal from the first, and second recorder, which produces the face and/or countenance signal, a video pattern system such as to address a memory to generate a wave form via the face signal from the image negative system, a comparator system for, so, comparing the face signal by a preset face signal, and a way for outputting a commandment signal, when such signals match with one another, a control system having the memory so that when the face signal matches the preset signal stored in the memory, all motor switches define a mechanism to turn on the motor concerning to the commandment signal. The commandment signal having a system to turn off the motor, when the motor is on and the vehicle is parked. The memory has a system to store data of a transit user whereby a first shield is to be inputted, an enter switch, such, as to enter data of a user, and a set time to delete the data via a transit user depends upon a delete switch. The vehicle incorporates, perpetually defined batteries, all communication, and/or talking devices are to include, perpetually self-chargeable batteries, also. The batteries include a way to operate perpetually, whereby, two several hundred ton batteries are to provide power also, perpetually. The batteries thereby, having a way to operate perpetually, for all portable appliances, energy of (GOD) is to operate in homes, condominiums, office buildings, housing growths, banks, hospitals, airports and generating stations. The perpetual energy of GOD will not allow the USA to depend on foreign oil, as a working unit is reality. The energy in special vehicles define reservoirs to supply the cartridges.

### BRIEF DESCRIPTION OF THE DRAWINGS

Further objects and advantages given herewith about the present invention will thus, become apparent by the drawings and the preferred embodiments of the description herein;

FIG. 1 is a perspective view of two batteries regarding two battery chargers, which charges one another perpetually;

FIG. 2 is a block diagram simplifying perpetual energy;

FIG. 3 is a perspective view of an electric vehicle and a plug of its motor to fit a perpetual energy system outlet;

FIG. 4 is a side view of one voltage battery cartridge;

FIG. 4A is a counterpart via the cartridge about FIG. 4;

FIG. 4B is a block diagram of a LED, and motor circuit;

FIG. 5 is an enlargement about a side view illustrating the vehicle, its countenance entry, and motor starting mode;

FIG. 5A shows a face entry mode via a first embodiment;

FIG. 5B shows a face entry mode of a second embodiment;

FIG. 6 is a block diagram including a transmitter and a system control circuit for so receiving countenance signals;

FIG. 7 is a flowchart for describing countenance entry;

FIG. 8 reveals the conventional electric vehicle motor;

FIG. 8A shows one video recorder, and an adaptor (ADA);

FIG. 8B shows a foot pedal of the Broadening paragraph;

FIG. 9 is a perspective view of a dashboard including a face shield, a motor switch, entry, delete, and ACC. switch;

FIG. 10 is a block diagram for describing the circuitry control concerning elements via the vehicle, and its system;

FIG. 11 shows a face shield in the vehicle on its door, a motor switch, an entry, delete, and an accessories switch;

FIG. 12 is a block diagram about the circuitry control;

### DESCRIPTION OF THE PREFERRED EMBODIMENTS

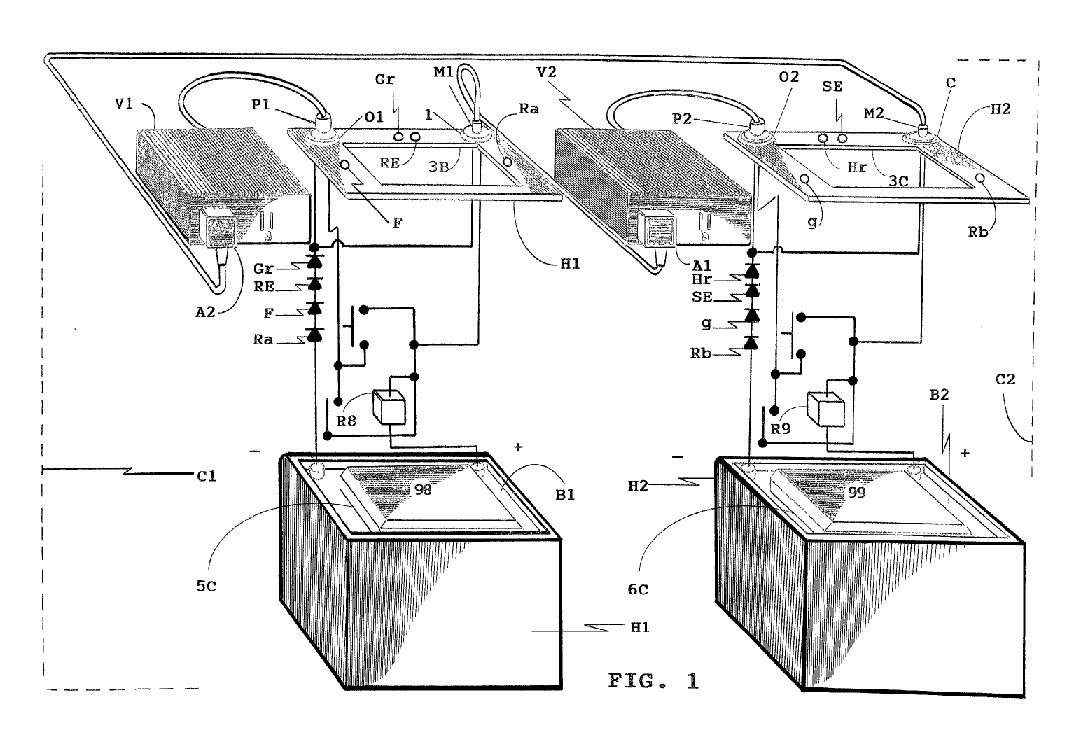

Referring to FIG. 1, dual conventional battery chargers H1-H2 charges one another, as two LEDs Ra and Rb glow on the chargers. This charger H1 uses a battery B1, as the charger H2 defines a battery B2 of a Perpetual Motion Energy system. Electrochemical at which oxidation occurs in these cells are complex alloys, thus containing many metals such as an alloy of V, Ti, Zr, Ni, Cr, Co, and (!) Fe.

A plug P1 of a DC-AC converter V1 fits an output outlet O1 on the charger H1. A DC-AC converter V2 has a plug P2 in an output outlet O2 upon the charger H2. This system causes each 12 V battery to charge one another, as an AC adapter A1 fits a charger jack 1 by a male plug M1 upon the charger H1. As the adapter part A1 plugs in the converter V2 the battery B2 outputs current that charges the battery B1. Now this is done, as an AC adapter A2 fits a charger jack C by a plug M2 on the charger H2, the adapter A2 plugs in the converter V1.

Now when the battery B1 is charging the battery B2, the output outlet O1 upon the charger H1 outputs 12 V DC current by which the converter V1 converts into alternating current. The current flows through this adapter A2, its lead, and the plug M2 via the charger jack C. This charges the battery B2 whereby, the battery B2 is likewise charging the battery B1.

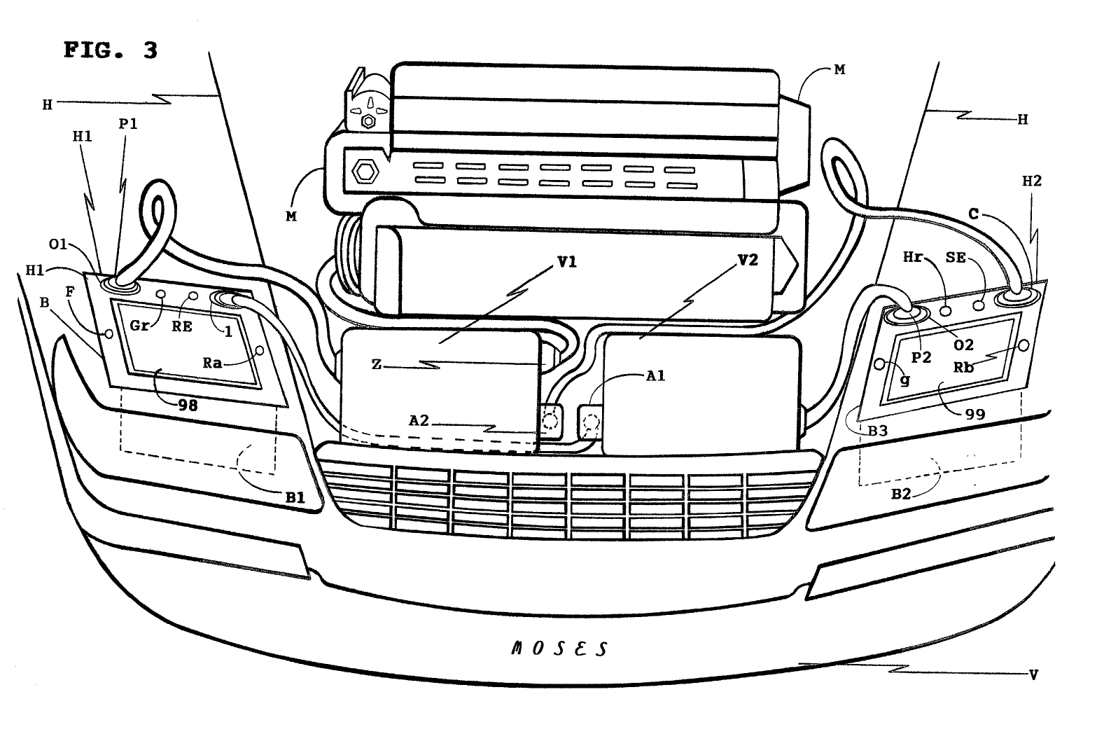

Two relays R8, and R9 prevent both batteries B1-B2 from overcharging, as these LEDs Ra-Rb glow as each battery B1 to B2 chargers each other. Two LEDs Gr-Hr glow as each battery B1-B2 endures a full charge. As the LEDs Gr-Hr and two LEDs RE-SE glow compatibly, each battery B1-B2 is satisfactorily, defined as being charged. Yet, each relay R8-R9 engages its contacts to close each charging circuit C1-C2, as this also, defines that each battery B1-B2 must be, eventually charged. The batteries B1-B2 charge one another, so, a full charge is done, two LEDs F-g emit light. These batteries B1-B2 charge one another to sustain a full charge, even, when an electric motor M of a vehicle V is turned off, as shown in FIG. 3.

While each battery in each circuit uses the same amount of voltage, each circuit induces the same amount of current. This causes the batteries B1-B2 to charge one another, until each relay R8, and R9 opens the charging circuits C1, and C2 with respect to disengagement of their contacts.

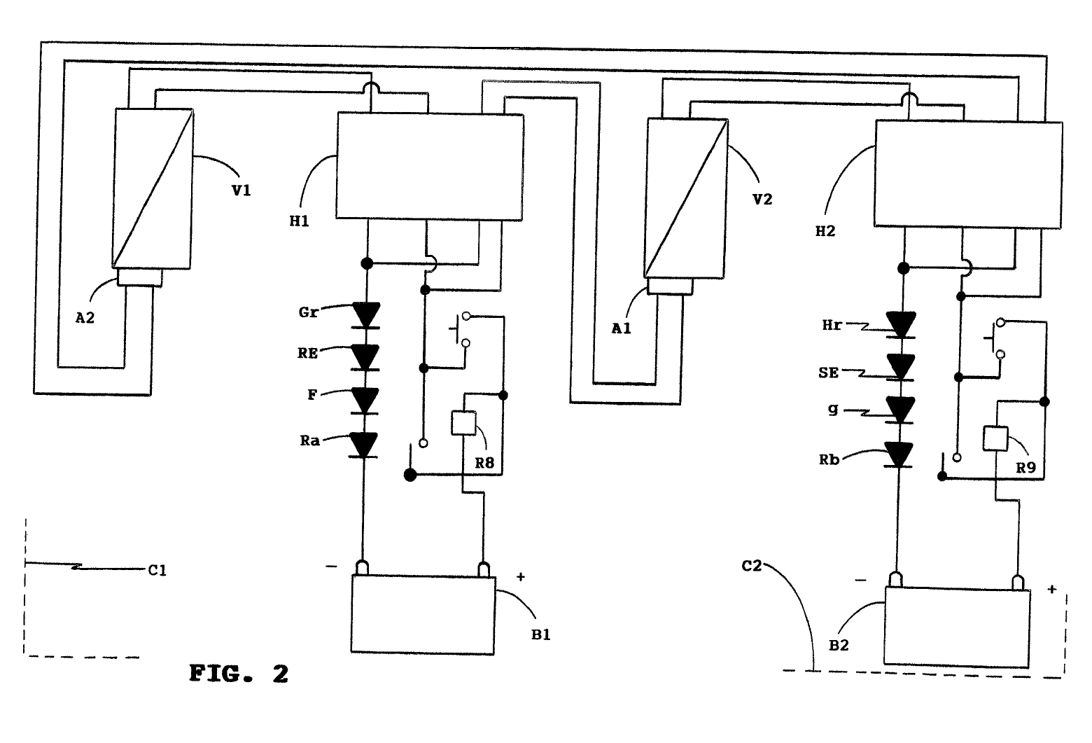

As shown in FIG. 2, the DC-AC converter V1 is connected to the charger H1, as the DC-AC converter V2 is connected to the charger H2, each battery B1-B2 charges one another as an end of the AC adapter A1 is connected to the charger H1. As the AC adapter part A1 is plugged into the converter V2, the battery B2 outputs current that charges the battery B1. Now this is done as a lead of the adapter A2 is connected to the charger H2, since its adapter portion A2 is plugged into the converter V1. The relays R8 to R9 are connected to an input terminal of the converters V1-V2. The LEDs Gr-SE emit light as each battery B1-B2 requires charging, all LEDs Ra-Rb, Gr, RE, Hr, SE, F, and g are connected via the other terminal of the converters V1-V2. The LEDs F-g glow, while each battery B1 to B2 is, fully charged by (PME) perpetual motion energy.

Referring to FIG. 3, this PME system is disposed in the vehicle V under a hood H, as the charger H1, and its battery B1 fit in a battery box B, the charger H2 and its battery B2 fit a battery box B3. A Polarized plug Z via the motor M is plugged in this DC-AC converter V1. Besides, the embodiment about the PME system is such that alternators will function, conventionally since this system charges itself perpetually.

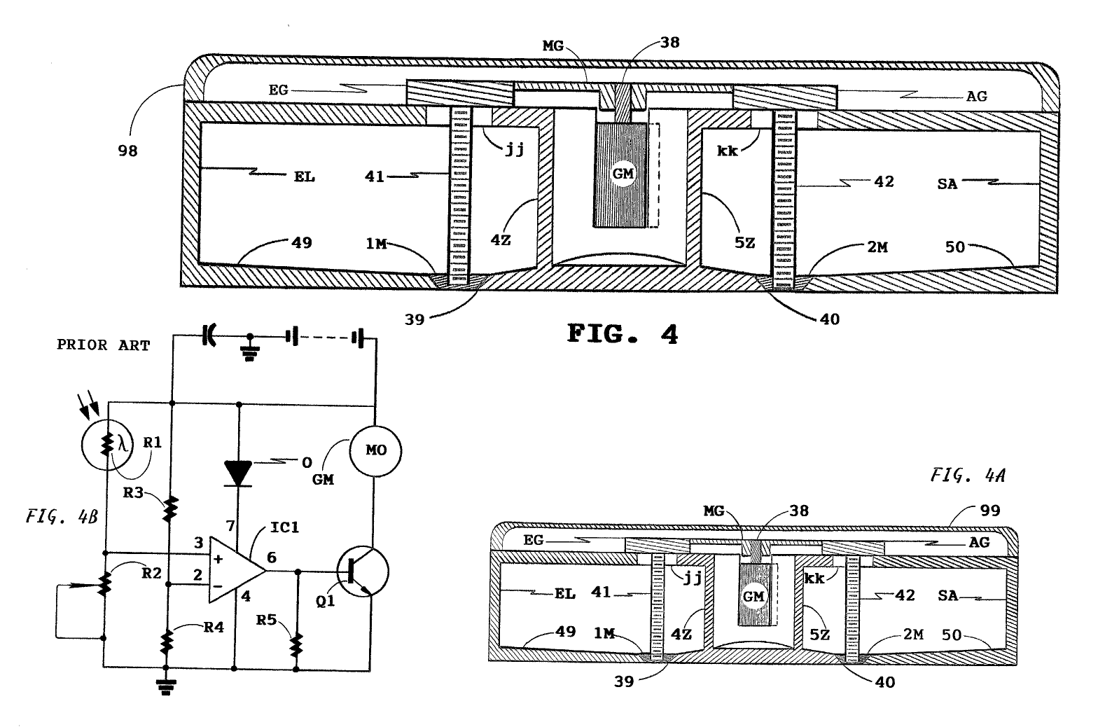

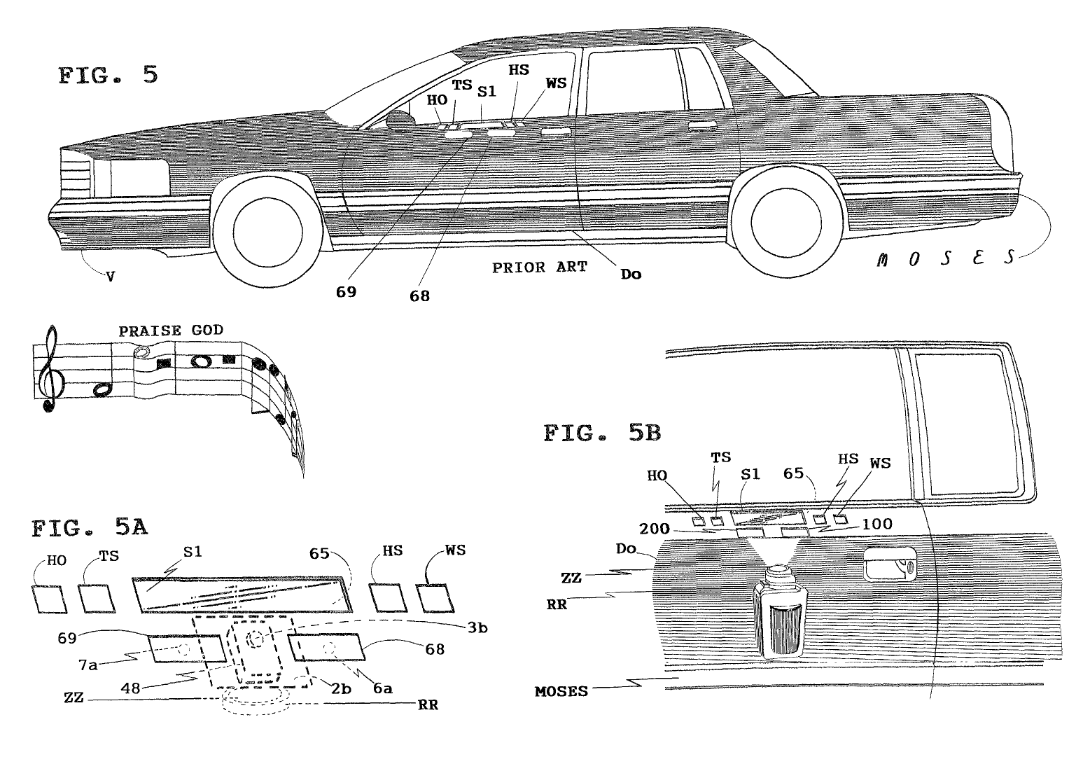

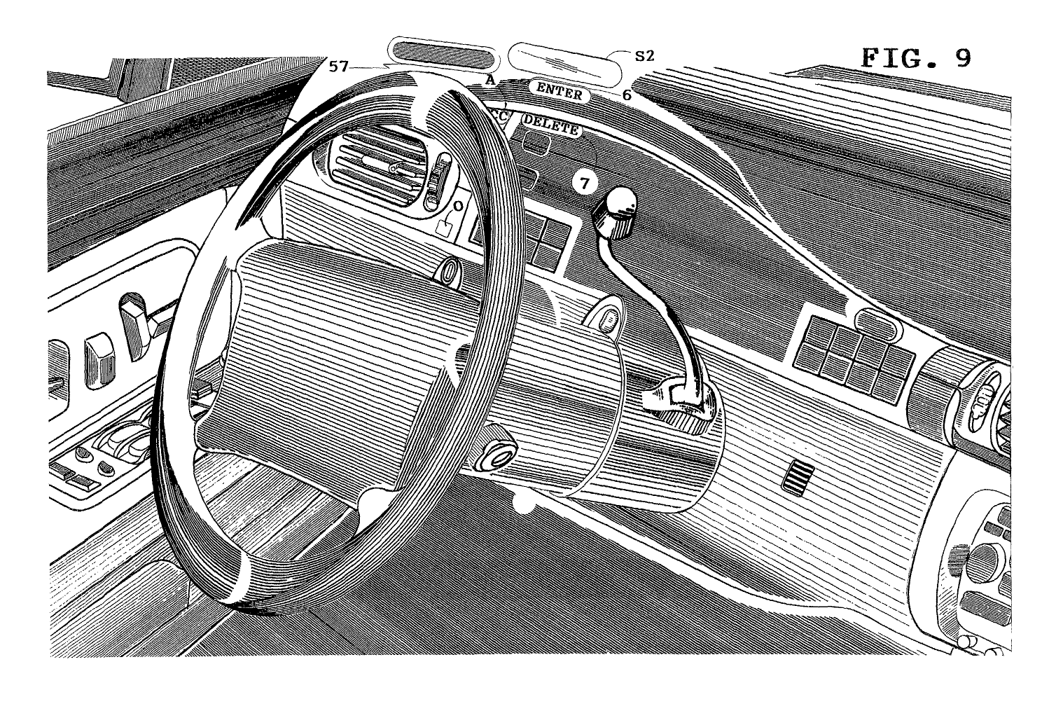

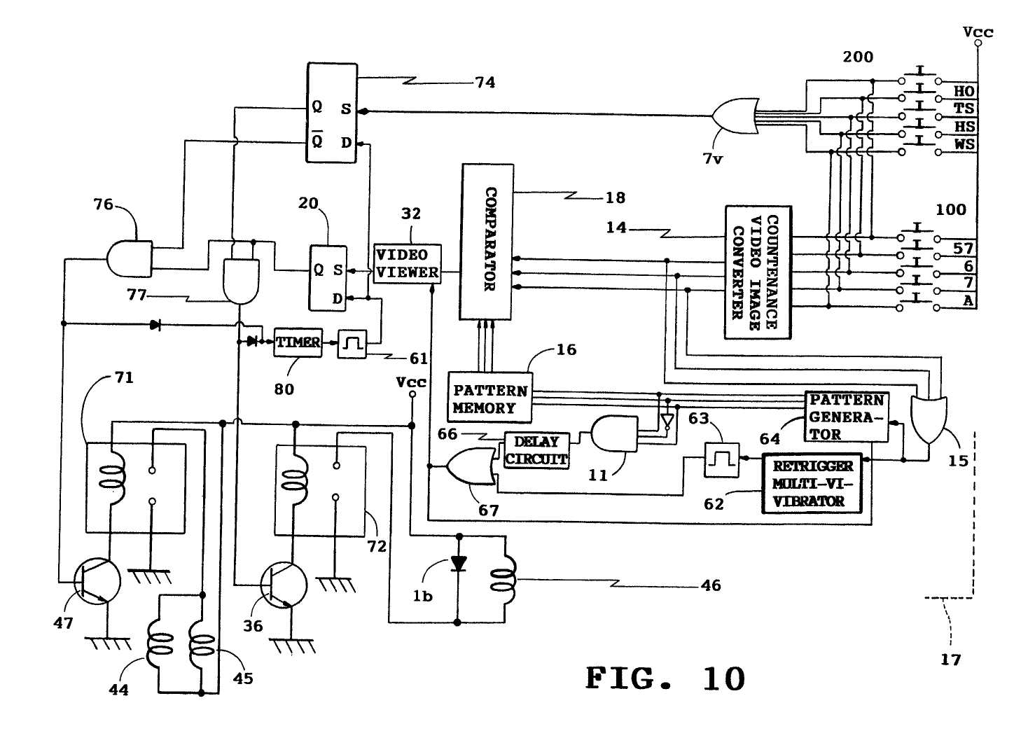

As PME electric vehicles exclude gas tanks, two several hundred ton batteries can provide PME the same as FIGS. 1-3. The PME system outputs current for charging each battery for ten years. As shown via FIGS. 4-4B, a LED 0 glows about two battery cartridges 98-99 after 9 years and roughly 9 months. A user has 3 months to return both battery cartridges 98-99. As the life of a prime battery is five years, each cartridge 98 to 99 restores its battery's voltage to a, fully, charged operating level for another five years. E.g., as this LED 0 emits light by its AC, or DC current-limiting resistor about a dashboard (FIG. 9), a gear motor GM having a gear MG about a shaft 38 is actuated by a CMOS op amp (IC1), which is used as a voltage comparator. This scans the levels of two input voltages and turns its output on or off based on which input voltage is, more. The input via pin 2 is set to a reference voltage of almost half the supply voltage by R3-R4, when the input on pin 3 is connected to a voltage divider R1, and one potentiometer R2. The resistance of a photocell changes, as the LED 0 emits light, the light intensity is, indicatively, shown by the voltage on pin 3 of IC1. The light level which turns on the circuit is fixed by R2. The output of pin 6 is turned on by R5, when the voltage about pin 3 of IC1 is more than pin 2, the output of IC1 drives a transistor Q1 so this transistor Q1 turns the motor GM on, and off via the op amp.

Referring to FIGS. 4-4B, as the LED 0 starts this motor GM, the motor gear MG is rotated clockwise, so, as to rotate an Electrolyte gear EG, and a Sulphuric Acid gear AG counter clockwise. This is performed simultaneously, since the gear MG is placed between both gears EG, and AG, so that two cone shaped plugs 1M-2M are rotated upwardly from two drain holes 39-40. The plugs 1M-2M are secured below two helixes 41-42. Two perforated blocks jj-kk using internal screw threads for receiving each helix 41-42. The gear EG is secured upon the helix 41, and the gear AG is secured upon the helix 42. The cartridges 98-99 have two tubs, namely, EL and SA. The tubs EL, and SA are divided via two walls 4Z-5Z, as a nonmetallic electric conductor Electrolyte in which current is, thereby, carried on an atom as ion, or the movement of ions, occupies the tub EL. As the atom ion carries a positive, or negative electric charge, this is a result of having lost, or, gained one or more electrons. Electrolyte is a substance that when dissolved in Sulphuric Acid becomes a fused ionic conductor. Accordingly, the Sulphuric Acid occupies the tub labeled SA.

As both floor surfaces 49-50 define an acute angle, the Electrolyte, and the Acid will drain smoothly, via the drain holes 39-40. This generates the voltage in the batteries B1 and B2 to a fully charged voltage status about modification. As shown in FIG. 1, each cartridge 98-99 is to extend by way of a cutout 3B-3C of the chargers H1-H2. The lower portions of the cartridges 98-99 will fit two battery cutouts 5C-6C.

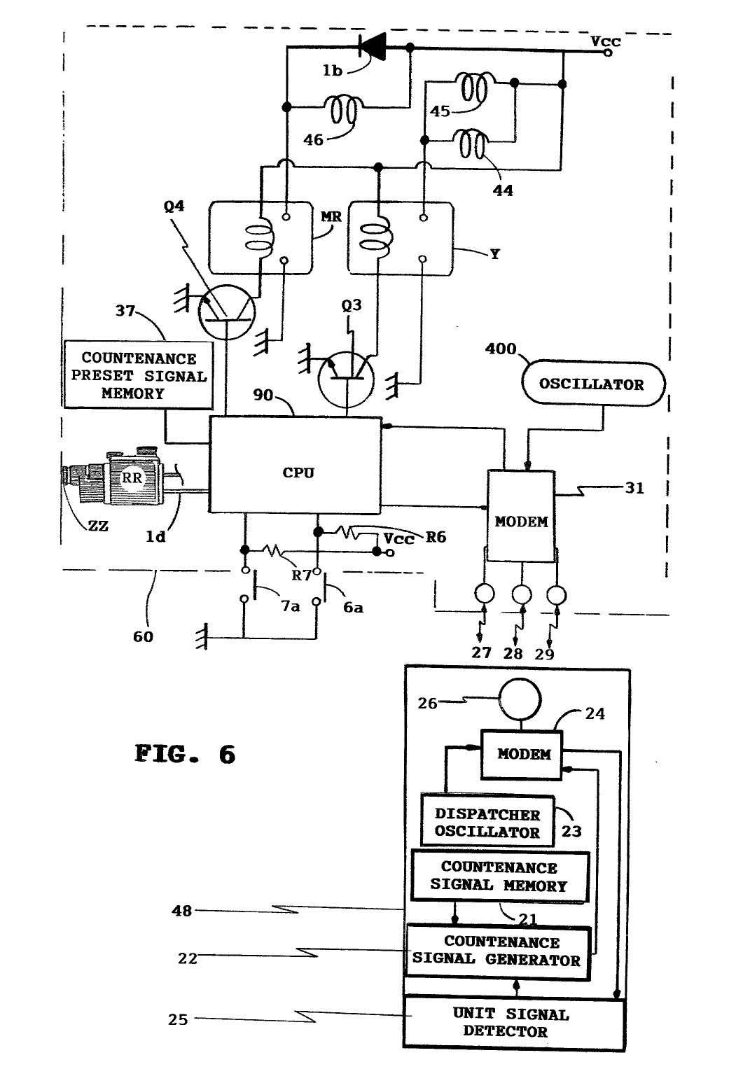

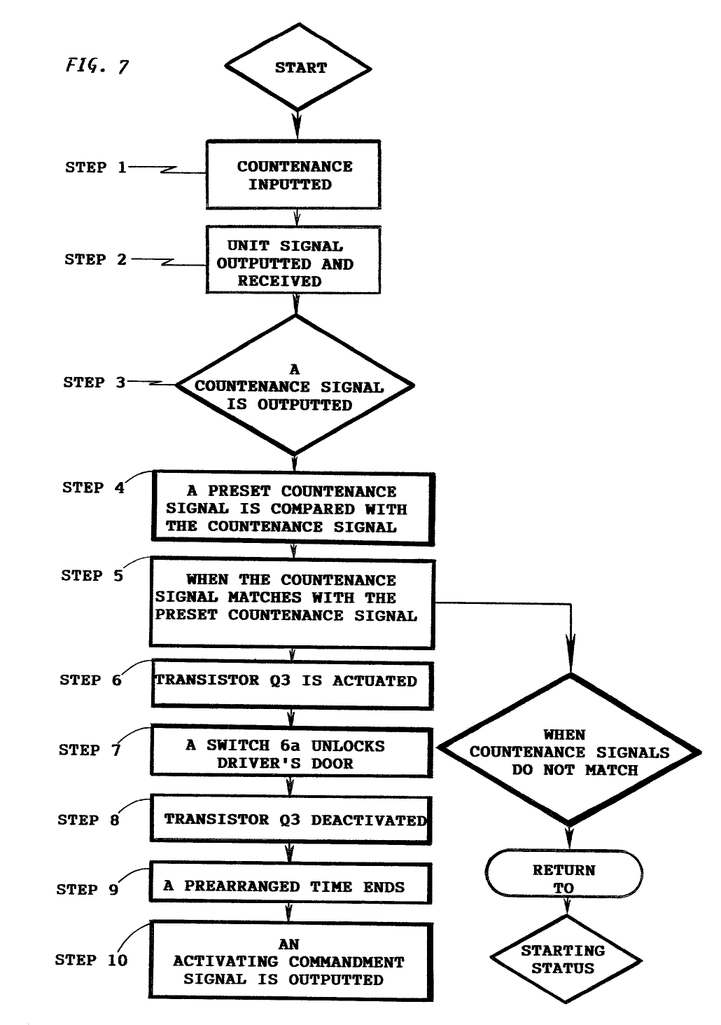

Referring to FIGS. 5-6, the vehicle V has a Face and/or Countenance Entry system, so, as a user pushes a first water proof unit switch 6a located upon one outer door Do, a first computerized video recorder RR is actuated. The recorder RR records a user's face when a user views a mirror-like shield S1. Such countenance, and/or face shield S1 lets a video be generated through its central transparent surface 65. Since the recorder RR is fixed perpendicularly below the shield S1 in the driver's door Do, the recorder RR records the face of a user, while the switch 6a is actuated to gain legal entry.

Since a first input system has countenance or face data inputted optically, to become computer data, or a signal via an image sensor, a face, or countenance signal is outputted, as a LED 1b illuminates the shield S1. The recorder RR uses a white balance system for illuminating the face input to be recorded, also. This video recorder RR is made up of a lens ZZ, as the sensor is a pickup device, which views this input so, as to change it into the face signal, a receiving system 27-29 receives this face signal from a transmitter 48. As a focusing system measures the distance below this face shield S1, as emitting infrared rays, detects bona-fide face input, when the shield S1 is viewed, as a pushbutton 68 is pressed. Infrared rays via an infrared light emitting is shot through a protecting lens to the face input. The input is hit while the rays reflect back using a receiving lens as entering the sensor. Since the sensor includes two photodiodes, a signal processing control system moves the receiving lens, so as to equalize the light intensity of the two photodiodes. When a drive pulse generator circuit generates pulses to drive this image sensor by a signal-processing circuit, the face signal is outputted, as the face input is inputted using any switch and the shield S1. While the sensor picks up the input, and feeds it to the processing circuit, outputs the face signal.

The first unit switch 6a is thus actuated by way of the pushbutton control 68, such as to provide countenance entry. Now a second unit switch 7a is actuated when its countenance pushbutton control 69 is thus pushed upon the outer door Do, switches on the vehicle's motor M via the countenance input.

As the transmitter 48, and the recorder RR are actuated compatibly, an actuator 2b actuates a push-button 3b of this transmitter 48, as each button 68-69 pushes the actuator 2b . The transmitter 48 stores the face and/or countenance signal in its countenance memory 21, while the shield S1 is viewed.

The transmitter 48, and the recorder RR are fixed in the door Do and defined as the input system including the shield S1. The control 69 which turns on the motor M is below, the shield S1 whereby adjacent to the control 68, two door-locks are freed, and the motor M is turned on even before the door Do is opened, when each switch 6a-7a is activated by a user.

Referring to FIG. 6, the transmitter 48 has one antenna 26 to receive, and transmit radio signals by three receiving antennas 27-29 as a central processing unit CPU 90 controls. The transmitter 48 has the face signal memory 21, a modem 24 to serve, as a demodulator via received unit signals, and is to generate output signals of which are transmitted via face data input regarding the face, and/or countenance signal.

A unit signal detector 25 is to detect the unit signals demodulated in the modem 24. A countenance signal generator 22 is for receiving the face signal, which proceeds from the countenance signal memory 21. The countenance signal is now outputted from the countenance signal generator 22 up to the modem 24, subsequently to any unit signal being so detected. Lastly, a dispatcher oscillator 23 is to output a dispatcher signal due to the course of the countenance signal, thereby, being transmitted with respect to the transmitter 48.

A controller 60 in the vehicle V has the antennas 27 to 29 to transmit, and receive radio signals by the transmitter 48. A modem 31 demodulates signals received, yet, generates output signals to be transmitted to the transmitter 48. The system by which the unit signals are transmitted relies upon the receiving system, i.e., the three antennas 27, 28 to 29.

As an oscillator 400 is provided to output a dispatcher signal, the CPU 90 is to control a face system, and a memory 37 is to store a preset face, and/or countenance signal. As the face signal matches the preset face signal such as to be decided by the CPU 90, a transistor Q3 is triggered. A coil of a relay Y is hot as the transistor Q3 is triggered. This relay Y is, also, connected to many automotive devices, as a door-lock device, one trunk opener, power windows, a heater, a hood opener, and a steering lock device. A coil 45 via an actuator is for freeing a door-lock of a user's seat section yet, a coil 44 of an actuator is for freeing a door-lock via a commuter seat section, since the steering locks by a timer only, as the vehicle is parked. A coil 46 of an actuator is to cause the LED 1b to illuminate this face input shield S1. As the relay Y is hot, the door-locks are freed, and the LED 1b is actuated by the switch 6a, since the unit switch 6a is connected to the input terminal of the CPU 90. Besides, the CPU 90 will compare the tracing extremity of this input face signal generated, as the unit switch 6a activates this video recorder RR, whereby a resistor R6 is provided.

As shown in FIG. 7, a step-by-step flow-chart is added.

Step 1, the unit switch 6a is activated, when the input shield S1 is inputted with real countenance data via a legal user, as the control 68 is pushed, incorporates legal entry

Step 2, the unit signal is transmitted via the antennas 27-29 to the antenna 26 that is found in the transmitter 48. The transmitter 48, and the recorder RR are turned on by the buttons 68-69 actuating the unit switches 6a-7a . Since this unit signal is received by the antenna 26 of the transmitter 48, this unit signal detector 25 detects the unit signal, so that the face signal is analyzed from the face signal memory 21, however, to the face signal generator 22.

Step 3, when the face signal is outputted by the signal generator 22 and through the modem 24, the modem 24 receives a dispatcher wave generated by the dispatcher oscillator 23. This face signal is covered by the dispatcher wave to form a radio signal since the face signal travels on the dispatcher wave. When the modem 24 transmits the face signal by way of the antenna 26 to these antennas 27-29, the preset signal is programmed out from the countenance memory 37 to the CPU 90.

Step 4, the CPU 90 utilizes the memory 37, and compares the countenance signal thereby the preset countenance signal from the transmitter 48, whereby through the antennas 27-29.

Step 5, when the countenance signal so matches with the preset countenance signal, the transistor Q3 is activated in step 6, as the relay Y is hot such that the current flows by way of the coils 44, 45, 46, and the LED 1b. As a rule, the door-locks are freed, as this LED 1b emits light. Now, when a match is not, decisively defined by the CPU 90 about these countenance signals, the face system returns to its starting status. When a user's true countenance is recorded via this shield S1 while the switch 6a is actuated, unlocks this door Do in step 7. This will allow legal entry for a legal user.

Step 8, the transistor Q3 is deactivated via the timer, which is setoff to start timing a prearranged time when such prearranged time has ended, which is, roughly, 25-30 seconds in step 9. Now the LED 1b and the actuators are deactivated also. The steering lock is released, only, as face input is inputted as the switch 7a is actuated, turns on the motor M.

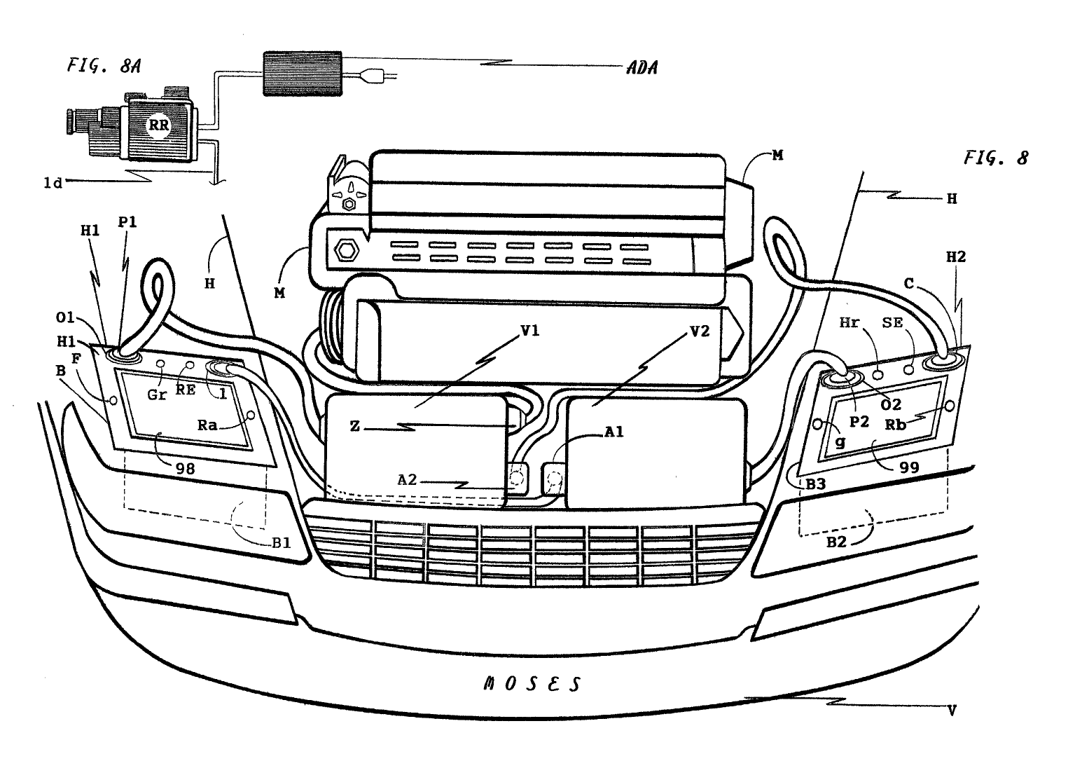

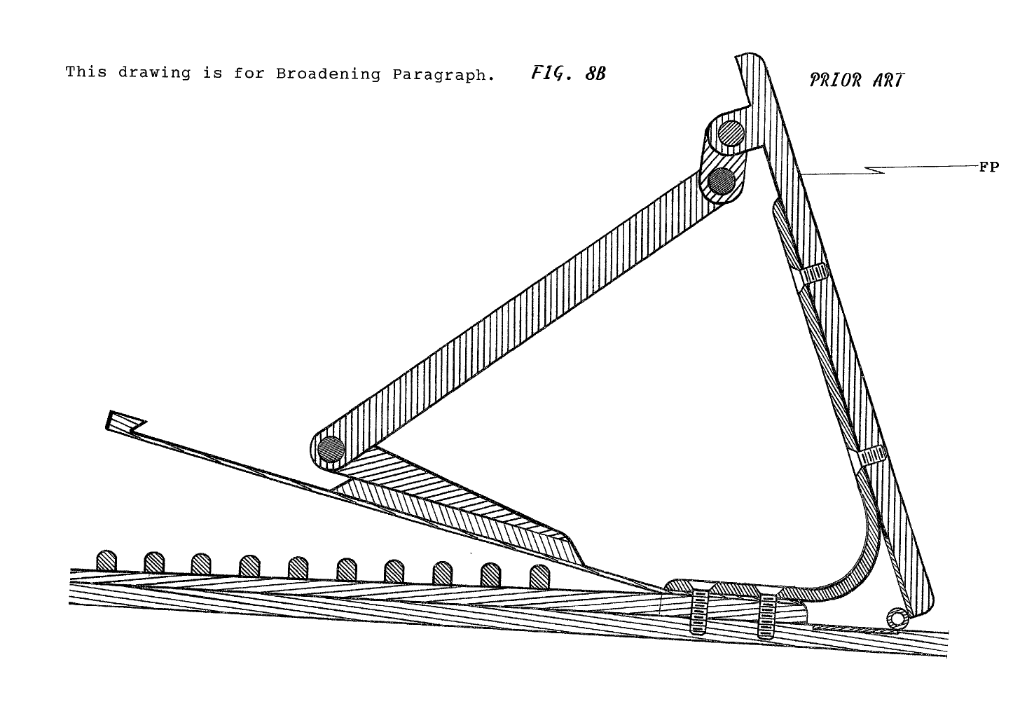

Step 10, the CPU 90 outputs a commandment signal as the countenance signal matches the preset signal which is stored in this memory 37. The vehicle V will now be referred to as Moses with respect to a reference name regarding this unique invention, which was granted to applicant from GOD ALMIGHTY. As shown in FIGS. 8-8A, the motor M indeed, incorporates the Polarized plug Z. The recorder RR being defined by an (ADA) adaptor which will be connected to a DC source, as an output cable 1d is connected to the input terminal of the CPU 90.

Thus, the recorder RR can be operated from this ADA, or will charge up its batteries, as the face input is inputted, since the perpetual DC supply voltage of Moses is lowered or thereby, raised according to the operating voltage about the recorder RR. Since the switch 7a is connected about the CPU 90, the antennas 27-29 will transmit the unit signal to this transmitter 48, as a user activates the unit switch 7a while viewing the countenance shield S1 simultaneously. This will cause the motor M to be turned on by the commandment signal, since the transmitter 48 thereby, answers the unit signal by transmitting the countenance signal.

A resistor R7 is provided via the switch 7a, and in the same manner as set forth above by modification, a transistor Q4 is provided also. As a rule, the motor M is only, turned on when a match is determined by the CPU 90, seeing that the transistor Q4 is for turning on the motor M regarding Moses, when a relay MR is hot. As a result, the commandment signal is outputted, whereby, the electric current concerning Moses flows through a coil via this relay MR about the prearranged time of the modification. Thus, the transistor Q4 is turned off, such that the operation returns to a starting position.

This transistor Q4 is engineered to turn on the motor M of Moses, when the foundations of the transistors Q3, and Q4 are connected to the output terminals about the CPU 90. The adjacent transistor Q3 is for freeing both door-locks, since this motor M, and all accessories regarding one clock, power windows, a radio, or the like are actuated as the transistor Q4 is turned on, and the coil of the relay MR is hot.

The collector of this transistor Q3 is connected to the hot coil of this relay Y, and to a collector bias source Vcc of the CPU 90. The emitter of the transistor Q3 is grounded as an end of these coils 44, and 45 of actuators for freeing the door-locks is connected to a lead via the collector bias source Vcc, the other end is grounded through the relay Y.

As the transistor Q3 is actuated, the coil of the relay Y is hot, such that electric current flows through the coils 44 and 45 that unlocks the doors of Moses. The collector of this transistor Q4 is connected to the coil cf the relay MR, and the collector is connected via the collector bias source Vcc. The emitter of this transistor Q3 is grounded, and one lead of the coil 46 of actuator, such, as to cause the motor M to be turned on is connected to this collector bias source Vcc, while the other leads are grounded using this relay MR.

The LED 1b is connected about the collector bias source Vcc, and the other leads are grounded through this relay MR. Since this transistor Q4 is turned on from legal countenance input and a match is determined, the coil of the relay MR is hot, so that electric current flows through the coil 46, and the LED 1b. The motor M of Moses is turned on as the switch 7a is activated by a legal user, the switch 7a turns off the motor M of Moses, as it is setoff once more by a legal user.

### Second embodiment

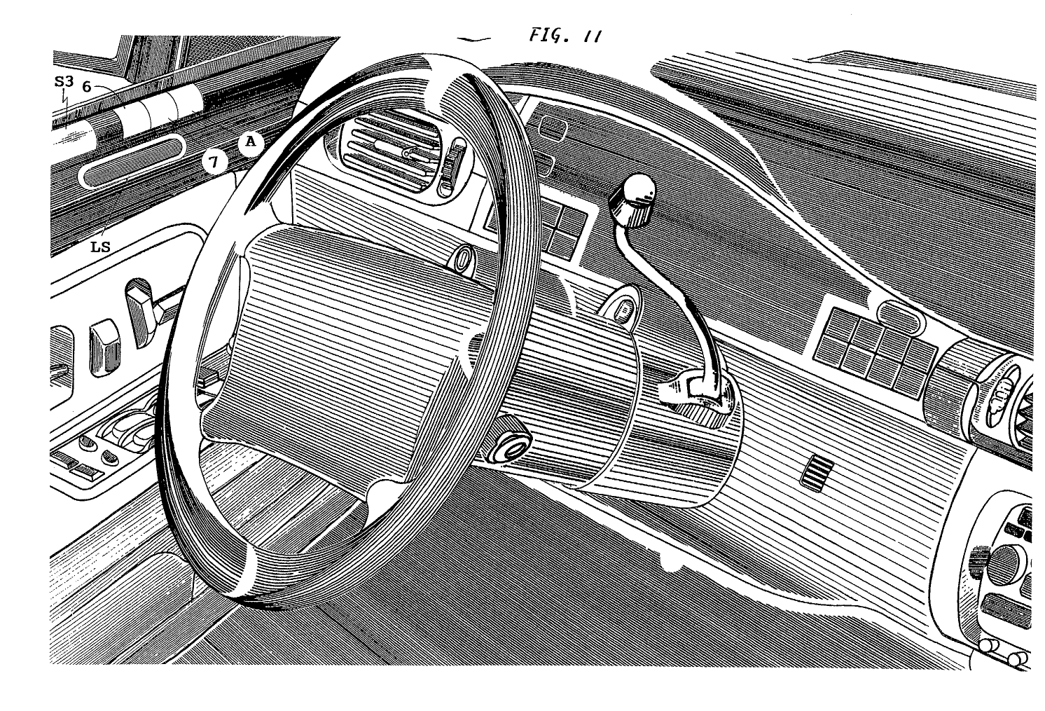

Now using new references and above comparable elements. Referring to FIGS. 9 to 10, a countenance input shield S2 is adjacent the dashboard, and a motor switch 57, as its enter, delete, and ACC switches 6, 7, and A are for thus, operating as follows: the face input pushbutton shield switch 57 turns on a second video recorder J (not shown), whereby located in the dashboard of Moses for changing optical information into computer data, turns on this motor M. This face input enter switch 6 is for entering data of a transit user, as the face delete switch 7 is to delete the data of a transit user, the ACC A switch actuates the accessories that are controlled by a user's face. When such face is recorded by the recorder J through the shield S2, while the switches 57, 6, 7 and A are operated, each switch will perform its operation compatibly.

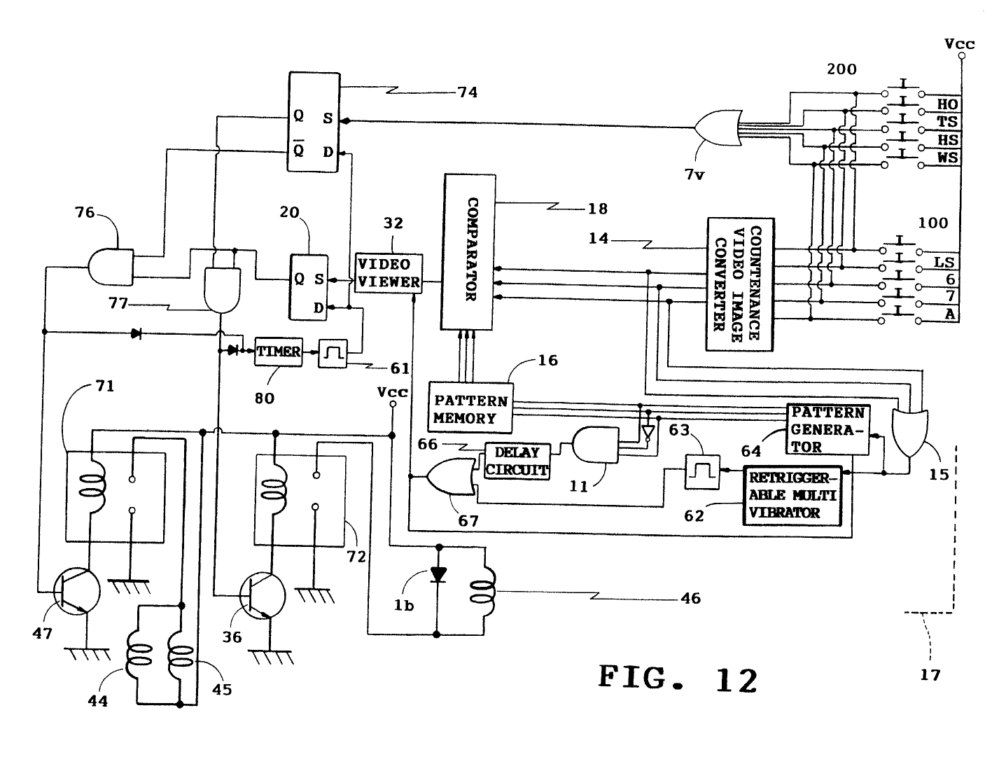

Referring to FIGS. 11 and 12, here is a more affordable system, which has a pushbutton motor switch LS. This switch LS includes a face shield S3 found in the vehicle Moses upon the door Do, so as to input face data optically through this system using the recorder RR. As this motor M is turned on, as set forth above concerning modification, the motor switch LS is setoff while being pushed by a user, so as to activate the recorder RR to turn on the motor M in the sane manner.

Generally, the motor switch 57 including the recorder J is excluded from all vehicles defining this LS system, since the input computerized video recorder RR provides face entry and motor starting prudently, regarding the motor switch LS.

The input shield S3, its enter, delete and ACC switches 6, 7, and A are designed so that when each switch is pushed, while the face of a user is recorded through this shield S3, each switch is to power its operation via modification. The switch LS is only in vehicles omitting the switch 57, while this switch 57 is only in vehicles excluding this switch LS. Since Moses comprises a controller 17 about this countenance and/or face input system, such system incorporates ten input switches. One heater push-button switch HS, a window switch WS, a hood switch HO, and a trunk switch TS each of which is upon the outer door Do. E.g., each switch being pushed when a user's countenance is being recorded however, will promote each switch to operate its function simultaneously.

Referring to FIGS. 5 and 10, the door Do includes these four input countenance pushbutton switches HO, TS, HS and WS outwardly, and adjacent to each side of this face shield S1, so that the input countenance shield S1 appears in the midst thereof. E.g., the hood switch HO actuates the hood opener, the switch TS is for triggering the trunk opener, the switch HS is for turning on the heater, while this switch WS is for the window control operations. These switches are operated, before a user opens and enters through the door Do of Moses.

Referring to FIGS. 10 and 12, a countenance video image converter (FVI) converter 14 is for thus, converting signals outputted which are produced while countenance input is, yet inputted through the recorders RR, and J to activate a motor switch 200 including switches HO, TS, HS, WS, 100, 57 and/or LS, 6, 7 and A which are ten switches without the switch LS.

An OR-gate circuit 15 is so that a logical amount of in put signals are generated from the FVI converter 14, a video pattern generator 64 comprises a clock for driving a counter change. This addresses a preprogrammed video pattern memory 16 (PVPM) for generating a video waveform. Now this outputs address signals on the output signals from the FVI converter 14, and the memory 16. Further, this controller 17 includes a comparator 18 so as to compare all output signals, thereby specifying data from this FVI converter 14. When all output signals defined by data from this memory 16 are outputted, a high-level logic signal is outputted, also, when this output signal from the FVI converter 14 matches the output from the output signal within the memory 16. A video negative viewer 32 inverts the video of this countenance input, and produces a negative image on the video of the countenance signal, so, as to match with this output signal from the memory 16. A D type reset S flipflop circuit 20 is set by the output signal of this video negative viewer 32. Besides, this outputs the commandment signal, such as to turn on a transistor 47, as a timer 80 is to thus time a preset time by which the flipflop circuit 20 outputs the commandment signal.

Now when the preset time is ended on this timer 80, the transistor 47 is turned off and a one shot multi-vibrator 61 is actuated. The flipflop 20 is reset via the transistor 47 being turned off, as a retriggerable multivibrator 62 is now actuated in reply to the output signal of the OR-gate 15. A one-shot multi-vibrator 63 is for outputting a pulse signal, however, of this preset time on the tracing extremity via an output signal of the multi-vibrator 62. Since this one-shot multi-vibrator 63 resets the video negative viewer 32, while utilizing this OR-gate 15, when the preset time is ended, an AND-gate 11 circuit is included for producing an output that is logical. A delay circuit 66 delays the output signal via this AND-gate 11 for the preset time. An OR-gate circuit 67 originates a logical amount of input signals from the output of this one-shot multi-vibrator 63, thus defining the output of this delay circuit 66. While the video pattern generator 64 outputs an address signal figurative via this countenance signal, whereby, outputted from the FVI converter 14 and the memory 16, a high level logic signal is outputted by the AND gate 11 as the delay circuit 66 obtains the high-level logic signal. This is also received by way of the OR-gate 67, and is done only, when the preset time has ended. Now the video negative viewer 32 is reset when the output signal of the OR gate 67 is outputted. Electric current flows by these coils 44 to 46, the LED 1b and a relay 71, since the transistor 47 answers the output signal from the flipflop circuit 20.

As shown in FIG. 5B, each face switch 200-WS and 100 on the outer door Do, which when inputted by way of a user, now activates the hood opener, the trunk opener, the heater, and the window control system, whereby, this LED 1b emits light. Door-lock actuators are actuated via the switch 100, thereby a legal user for gaining countenance entry via modification. The countenance input switches are actuated in the dashboard whenever electric current flows using the coils 44-46, also. While the memory 16 comprises a system for storing data of a transit user, when such user pushes the switch 100 and views the face shield S1, a legal user operates the face switch 6. The countenance input each of which becomes computer data by the image sensors, signal circuits and associated components concerning such input. Further, the face data each of which is compared via the comparator 18, as the output signal from the FVI converter 14 matches the output signal of the memory 16, a signal of a transit user is stored into the memory 16. The flipflop circuit 20 outputs the commandment signal after being set by the output signal of this video negative viewer 32, the commandment signal actuates the time 80. This timer 80 starts clocking a preset time to delete this data about a transit user, as an image about this data of a legal user is generated alone by the viewer 32, the input switch 7 deletes the transit data at the preset time which is only 3 seconds.

While a user enters Moses, when pushing the switch 100, the countenance signal is outputted from the recorder RR, so that the FVI converter 14 converts the face signal that goes to the comparator 18. The signal is now sent through the OR gate 15, and further to the pattern generator 64. Since the pattern generator 64 has 43,605 pixels so that each pixel is programmed, a switch provides a choice of custom patterns.

Notwithstanding, this generator 64 addresses the memory 16 by an address signal in reply to the face input as a user operates this switch 100. A preset face signal is outputted from the memory 16 to the comparator 18. This comparator 18 compares the face signal from the FVI converter 14 with this preset face signal, therefrom the memory 16. While the face signal matches with the preset face signal, a twofold signal is outputted from the comparator 18. As this negative image of the face signal matches the preset signal from the memory 16 as the comparator 18 outputs the preset signal, the video negative viewer 32 outputs the commandment signal.

Now the commandment signal is outputted to the flipflop circuit 20, since the flipflop 20 is set on the basis of the commandment signal. As the flipflop 20 outputs a high level signal by a terminal Q to the bed of the transistor 47, this transistor 47 is turned on as the relay 71 is hot. Electric current flows via the coils 44-46 and the LED 1b. The motor M of Moses is started, as a user's face is recorded when the switch 57 is pushed. The enter and delete switches 6-7, and the dashboard ACC switch A operates only, when the face of a legal user is recorded, while each switch is being operated.

When the LED 1b emits light, after being activated, the timer 80 starts timing the prearranged time, as set forth in the foregoing with respect to modification.

Referring to FIGS. 9, and 10, one OR-gate circuit 7v is connected to a terminal S of a flipflop circuit 74, as these switches 200-WS are connected via the OR-gate 7v. While the bases of the transistor 47 and a transistor 36 are connected to an output terminal of an AND-gate 77, the flip-flop 74 is set by the output signal from the OR-gate 7v. Besides, this transistor 47 is to free the door-locks while the transistor 36 is for turning on the motor M of Moses, and to setoff the LED 1b. Since the collectors of these transistors 47 and 36 are connected to a hot coil of this relay 71, and a coil via a relay 72, the collectors are connected to a collector bias source Vcc, as the emitter of the transistors 47, and 36 are grounded. As a lead via the coils 44 to 45 of actuators for freeing these door-locks is connected via the collector bias source Vcc, the other lead is grounded by this relay 71. As a lead about the coil 46 is connected via the collector bias source Vcc, the other lead is grounded through the relay 72.

Since the output terminal Q of the flipflop 20, and one output terminal Q to invert this flip-flop circuit 74, while connected to the two input terminals of one AND-gate 76, the two input terminals of the AND-gate 77 are connected via the output terminals Q of the flipflop circuits 74 and 20.

Further, the high level signals are outputted from this output terminal Q-Q about the flipflop 20, and 74 to the AND gate 76, simultaneously while the countenance signal matches via the preset countenance signal in reply to the input face switches 100, 57, 6-7, and A. An output signal is outputted from this AND-gate 76 to the transistor 47, seeing that this transistor 47 is turned on, as the relay 71 is hot. Now the door-locks are freed, as a legal user operates the entry and countenance switch 100. The switches HO to WS each of which is for performing its operation as set forth above regarding modification of the second embodiment via this construction. While a user's face is recorded when the motor switch 200 is pushed before entering Moses, a user will operate this motor switch LS while seated upon the driver's seat. This is done when the face signal matches with the preset face signal, as these high-level logical signals from the output terminals Q by way of the flip-flop 74, and 20 are received by two input terminals of the AND-gate 77. This is also done as an input terminal of the AND-gate 76, so receives a low level logical signal from this output terminal Q of the flipflop 74. This AND-gate 77 outputs an output signal to the transistor 36 to turn on the motor M by the face switch 200. Now this switch LS turns on the motor M of Moses also, using the AND-gate 77.

While this above description contains many specifics of which should not be construed as limitations on the scope of the invention, variations and modifications will be apparent to persons skilled in the art. E.g., the motor M is to have varietal speed switches having a system, so, as to deliver a top speed of 150 mph by a foot pedal FP as shown in FIG. 8B. Two several hundred ton batteries with perpetual energy will provide, such, energy regarding public utilities, generating stations, condominiums, banks, hospitals, office structures, housing developments, homes, and all communication machines. Vehicles in faraway lands will include two reservoirs, so as to supply two cartridges on two batteries to restore battery life, PME voltage in each battery is maintained perpetually.

(GOD) and I claim:

1. A perpetual energy system via GOD comprising: charging means having two batteries via a vehicle;
a first battery to fit a first charger, whereby, a second battery is sized to fit a second charger;
a first DC to AC converter means, and a first plug so as to fit a first hole on said first charger;
a second DC to AC converter means joining a second plug to fit a second hole on said second charger and means for said batteries to load each other;
a first AC adaptor and a third plug to fit a first jack upon said first charger, as said adaptor is to fit a socket via said second converter means, said second charger defines means for outputting DC current for charging said first battery;
a second AC adaptor and a fourth plug so as to fit a second jack about said second charger, as said adaptor is to fit a socket concerning said first converter means, said first charger having means to output current to charge said second battery; relay means for freeing said batteries from power; drain means for draining two battery cartridges.

2. A perpetual energy system as defined in claim 1, wherein said charging means has a first and second LED to say low charge, said relay means are to close two circuits.

3. A perpetual energy system as defined in claim 1, wherein said batteries have means to load perpetually, as a third LED says full, said relay means are to halt loading.

4. A perpetual energy system as defined in claim 1, wherein said batteries connected in series, and means for each circuit to operate, a fourth and fifth LED are to glow.

5. A perpetual energy system as defined in claim 1, wherein said charging means is to join an electric motor, said batteries have means to operate when said motor is off.

6. A perpetual energy system as defined in claim 1, wherein said cartridges have tubs of electric nonmetallic conductors, a solvent to dissolve, and a sixth LED on power.

7. A perpetual energy system as defined in claim 6, wherein said cartridges having two drain holes below, two plugs under two helixes, a gear motor and means to spin said plugs, two acute floor angles have means to drain said tubs.

8. A perpetual energy system via GOD comprising:
charging means having dual batteries each of which is located in one conventional battery charger;
DC to AC converter means for converting DC current to AC current regarding two DC to AC converters;
AC adaptor means for connecting, and charging said batteries by means of said DC to AC converters;
countenance entry means for entering a vehicle via face data inputted, optically, through one first shield and into a system, a first video recorder includes means to record a face of a legal user;
image sensor means for changing countenance images from optical input to computer data or a signal;
control means for controlling perpetual energy and means for outputting a commandment signal;
unlock means for freeing door-locks, and actuators activating, thereby means of a first unit switch to gain entry, a seventh LED is to illuminate;
a first input means having said first shield, said recorder, a transmitter and a second unit switch on said control means to so output a unit signal by said transmitter, turns on one motor by means of said switch when said face is being recorded;
said transmitter defining means to track said unit signal by transmitting a countenance signal;
comparison means for comparing said data having a memory to store a preset countenance signal, so, when said countenance signal matches said preset signal stored about said memory, said comparison means is for outputting said commandment signal.

9. A perpetual energy system as defined in claim 8, wherein said recorder, and said transmitter are in a door of said vehicle, three antennas are to receive each signal.

10. A perpetual energy system as defined in claim 9, wherein said vehicle is an electrical vehicle having dual battery boxes to fit said batteries within both chargers.

11. A perpetual energy system as defined in claim 8, wherein said motor having means for being activated, said vehicle has conventional means to be propelled on a surface.

12. A perpetual energy system as defined in claim 9, wherein said door has a heater switch, a window switch, a hood and a trunk switch outwardly and means to operate, each switch has means to operate, as said face is being recorded.

13. A perpetual energy system via GOD comprising:
a second input means defining a second shield in a dashboard to input data optically in a system to become computer data, and means to output a face and/or countenance signal, a second motor switch having means to turn on a motor via said shield;
video image converter means, so as to convert said signal from a first and second video recorder;
a third input means including a third shield and a third motor switch upon a door in a vehicle, and means for inputting optical data via a system to arise as computer information, outputs said face signal by means of said third motor switch;
image negative means for defining a negative image via said face signal from said first, and second recorder of said face and/or countenance signal;
video pattern means for addressing a memory, so as to generate a wave-form of said face signal from said image negative means;
comparator means for comparing said face signal by a preset face signal, and means for outputting a commandment signal as such signals mate thereby;
control means having said memory so that when said face signal matches said preset signal stored in said memory, all motor switches include means to turn on said motor via said commandment signal.

14. A perpetual energy system as defined in claim 13, wherein said commandment signal has means to incite said motor, and turn off said motor, when said vehicle is parked.

15. A perpetual energy system as defined in claim 13, wherein said memory has means to store transit data as a first shield is inputted and means to incite a first switch, an enter switch has means to enter data of a legal user as a set time and a delete switch is to delete said transit data.

16. A perpetual energy system as defined in claim 14, wherein said vehicle has, perpetually defined batteries, a talking device is to have self-chargeable batteries also.

17. A perpetual energy system as defined in claim 16, wherein said batteries having means to work perpetually, two several hundred ton batteries are to power, perpetually.

18. A perpetual energy system as defined in claim 17, wherein said batteries have means to operate perpetually for portable devices, energy of (GOD) is designed, and means to operate in homes, condominiums, office buildings, housing growths, banks, hospitals, airports and generating stations.

19. A perpetual energy system as defined in claim 18, wherein said energy of GOD is defined, the USA is not to depend on foreign oil, as a model of said energy is reality.

20. A perpetual energy system as defined in claim 19, wherein said energy in special vehicles in distant lands are to comprise two reservoirs, and means for supplying said cartridges, battery life is to be incorporated perpetually.
